(19) United States
(12) Patent Application Publication
(10) Pub. No.: US 2009/0110273 A1
(43) Pub. Date: Apr. 30, 2009

(54) Image Processing Device and Image Processing Program

(75) Inventors: Tomotaka Shinoda, Tokyo (JP); Toshihiro Mitaka, Hokkaido (JP); Satoshi Mori, Hokkaido (JP); Naoki Watanabe, Hokkaido (JP); Hideki Ito, Hokkaido (JP)

Correspondence Address: ARENT FOX LLP, 1050 CONNECTICUT AVENUE, N.W., SUITE 400, WASHINGTON, DC, 20036, US

(73) Assignees: NIKON CORPORATION, Tokyo (JP); SAPPORO MEDICAL UNIVERSITY, Hokkaldo (JP)

(21) Appl. No.: 12/280,520

(22) PCT Filed: Jul. 9, 2007
(86) PCT No.: PCT/JP2007/000742

§ 371 Date: Aug. 22, 2008

(30) Foreign Application Priority Data
Jul. 10, 2006 (JP) 2006-189607

(51) Int. Cl. G06K 9/36; G06K 9/00

(52) U.S. Cl. 382/165; 382/133

(57) ABSTRACT

An inspection apparatus includes an imaging device and an image processing device. The imaging device photographs a specimen and outputs a color image of the specimen to the image processing device. The image processing device subjects the color image of the specimen to negative-positive reversal. After detecting a mode value of the hue of the color image having been subjected to negative-positive reversal, the image processing device changes the hue of the color image in accordance with a difference between a boundary value of two predefined hues and the detected mode value. In accordance with the change of the hue, a plurality of target pixels different in the saturation is extracted and the saturation and the intensity of each pixel are changed, or the gradation of each pixel is converted so that the plurality of target pixels becomes most distant from one another in a color space.

### CROSS-REFERENCE TO RELATED APPLICATION

This application is a U.S. National Stage application claiming the benefit of prior filed International Application Number PCT/JP2007/000742, filed Jul. 9, 2007, in which the International Application claims a priority date of Jul. 10, 2006 based on prior filed Japanese Application Number 2006-189607, the entire contents of which are incorporated herein by reference.”

### TECHNICAL FIELD

The present invention relates to an image processing device and an image processing program that process a color image.

### BACKGROUND ART

In order to accurately diagnose various diseases of animals including humans, diagnoses of pathological tissues and cells are indispensable. Among others, information about kinds, numbers and shapes of cells included in blood and bone marrow is indispensable in many diagnoses of diseases, and therefore, cells are collected from blood and bone marrow and specimens are obtained and then a technical expert observes differences in shapes and color tones of the cells using a microscope and judges the kinds and anomalies of individual cells. Such tasks (in which a technical expert directly looks into a microscope and makes a judgment manually based on his/her own experience) are carried out routinely in an inspection room of hospitals all over the world.

For example, the measurement of the number of eosinophils in blood gives critical information for diagnoses of allergic diseases. The number of eosinophils has increased in blood of patients of pollinosis and asthma. For the diagnoses, blood is collected from a patient and the blood is smeared and fixed onto a slide glass, and then a technical expert observes the Giemsa-stained specimen by using a microscope with a magnification of 1,000 (liquid immersion). Then, the technical expert diagnoses based on the existence of eosinophilics (reference: “(Kensa To Gijutsu (Inspection and Technique)”, extra number, vol. 28, No. 7, 2000, IGAKU-SHOIN Ltd., “Standard Kensa ketsueki-Gaku (Standard Laboratory Hematology)”, compiled by The Japanese Society for Laboratory Hematology, Ishiyaku Publishers, Inc., 2003, 1 st edition).

On the other hand, thanks to the recent development of digital technologies, each element of a microscopic image is converted into digital information and it is made possible not only to directly project an image on a screen but also to process the image in a variety of ways using software. If the task of judgment based on the experience of a technical expert is generalized into a method by which any one can make a distinction, it is made possible to considerably reduce the time and costs for the task.

In such circumstances, a color image of a stained specimen is taken in and pathological diagnoses of the specimen are made based on the image. It is normal to identify the kinds of individual cells based on the differences in forms of specimen images that appear in the image (for example, refer to non-patent document 1). Instead of the diagnosis based on the differences in forms of specimen images, it is also proposed to identify the kinds of individual cells by plotting the values of each pixel of a color image of specimen in a predetermined color space and distinguishing the color differences for each kind of cell based on the sub-volume occupied by the values of each pixel in the color space (for example, refer to patent document 1).

Non-patent document 1: “Clinical & Laboratory Haematology, 2003, vol. 25, pp. 139-147”, “Differential counting of blood leukocytes using automated microscopy and a decision support system based on artificial neural networks—evaluation of DiffMaster Octavia”

Patent document 1: Japanese Unexamined Patent Application Publication No. 2003-506796

### DISCLOSURE

### Problems to be Solved

The method, in which color difference for each kind of cells is distinguished based on the sub-volume in the color space, is however an indirect method. Recently, it is desired to directly distinguish the color difference for each kind of cells in a color image (real image) of specimen and make a diagnosis based on the color difference. However, the color difference for each kind of cells in a real image is extremely small and it is not possible to explicitly distinguish the color difference on the real image.

A proposition of the present invention is to provide an image processing device and an image processing program capable of clarifying a slight color difference in a color image (real image) of specimen.

### Means for Solving the Problems

An image processing device according to a first invention includes a processing unit that finds a hue of each pixel of a color image, a detecting unit that detects a mode value of the hue, and a changing unit that changes the hue of each pixel of the color image in accordance with the difference between a boundary value of two predefined hues and the mode value.

In a second invention, the processing unit finds saturation and intensity of each pixel, in addition to the hue, and the changing unit also changes the saturation and the intensity, in addition to the change of the hue and changes the saturation and the intensity of each pixel of the color image so that a plurality of target pixels different in the saturation becomes most distant from one another in a color space including a hue axis, a saturation axis and an intensity axis, in the first invention.

A third invention further includes a converting unit which finds each color component of red, green and blue of each pixel of the color image based on the hue, the saturation and the intensity after the change by the changing unit and converts a gradation of the each color component so that the plurality of target pixels becomes most distant from one another in the color space, in the second invention.

In a fourth invention, the processing unit finds saturation and intensity of each pixel, in addition to the hue, and the device further includes a converting unit which finds each color component of red, green and blue of each pixel in the color image based on the hue after the change by the changing unit and the saturation and the intensity found by the processing unit and converts a gradation of the each color component so that a plurality of target pixels different in the saturation becomes most distant from one another in a color space including a hue axis, a saturation axis and an intensity axis, in the first invention.

In a fifth invention, the converting unit converts the gradation of each color component using a table, in the third or fourth invention.

A sixth invention includes an extracting unit that extracts the plurality of the target pixels based on a user instruction, in any of the second to fifth inventions.

In a seventh invention, the processing unit finds at least the hue of each pixel using the color image after having been subjected to negative-positive reversal, in any of the first to sixth inventions.

An eighth invention includes a selecting unit that selects a target area of a predefined hue value of the color image, in any of the first to seventh inventions.

In a ninth invention, the selecting unit selects the target area based on a user instruction, in the eighth invention.

A tenth invention includes a measuring unit that measures the number or area ratio of the target areas in the color image, in the eighth or ninth invention.

In an eleventh invention, the color image is a photographed image of eosinophil, in any of the first to tenth inventions.

An image processing program according to a twelfth invention causes a computer to execute a processing operation of finding a hue of each pixel of a color image, a detecting operation of detecting a mode value of the hue, and a changing operation of changing the hue of each pixel of the color image in accordance with a difference between a boundary value of two predefined hues and the mode value.

According to the image processing device and the image processing program of the present invention, it is possible to clarify a slight color difference in a color image (real image) of specimen.

### BRIEF DESCRIPTION OF THE DRAWINGS

FIG. 1(a) is a block diagram for illustrating a configuration of an inspection apparatus 10 and FIG. 1(b) is a diagram showing an example of a specimen 10A.

FIG. 2 is a flowchart showing a processing operation of a color image in an image processing device 12 in the present embodiment.

FIG. 3 is a diagram showing an example of a data path when processing a color image.

FIG. 4 is a schematic diagram of a color image after having been subjected to negative-positive reversal.

FIG. 5 is an explanatory diagram in which the values (hue/saturation/intensity) of each pixel after having been subjected to HSI conversion are plotted in a predetermined color space.

FIG. 6 is a diagram for illustrating a mode value (hue H₃₀) of the hue of each pixel.

FIG. 7 is a diagram for illustrating rotation of the hue H₃₀.

FIG. 8 is a schematic diagram of a color image after its hue has been changed.

FIG. 9 is a diagram for illustrating extraction of target pixels 31 to 34.

FIG. 10 is a diagram for illustrating a color space of a twin six-sided pyramid model.

FIG. 11 is a diagram for illustrating plot positions of the target pixels 31 to 34 after their saturation/intensity have been changed.

FIG. 12 is a diagram for illustrating an example of a gradation conversion curve (γ₁ to γ₃)

FIG. 13 is a diagram for illustrating the plot positions of the target pixels 31 to 34 when a sample distance has become maximum by the gradation conversion.

FIG. 14(a) is a diagram showing a color image after having been subjected to the negative-positive reversal of a specimen of bone marrow including Giemsa-stained eosinophils and FIG. 14(b) is a diagram showing a color image after having been subjected to the processing in FIG. 2.

### DETAILED DESCRIPTION OF THE EMBODIMENTS

### Description of First Embodiment

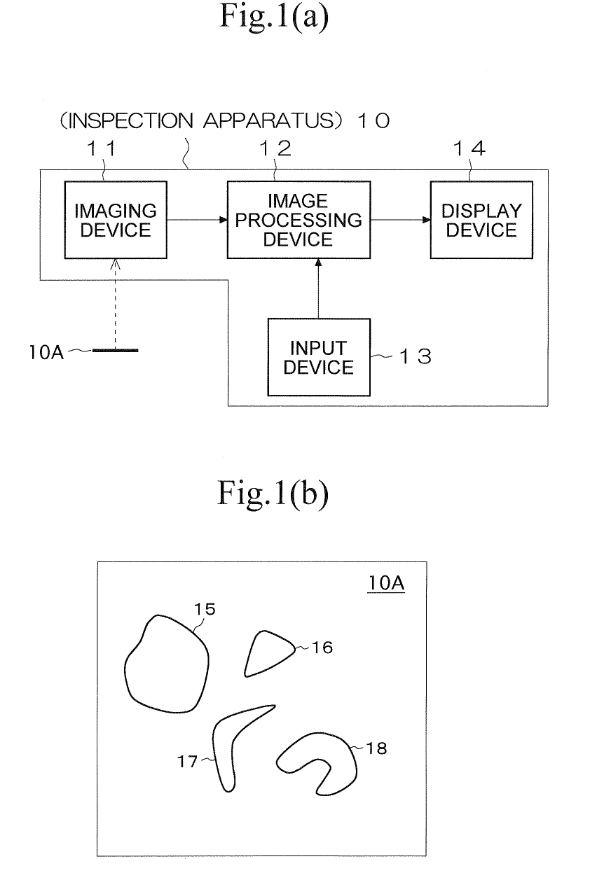

FIG. 1(a) is a block diagram showing a configuration of an inspection apparatus 10 in a first embodiment and FIG. 1(b) is an explanatory diagram showing, for example, a specimen of Giemsa-stained blood. The inspection apparatus 10 is used for pathological diagnosis of a specimen 10A. The specimen 10A is, for example, a specimen of Giemsa-stained blood, including a plurality of cells 15 to 18.

The inspection apparatus 10 is provided with an imaging device 11, such as a digital camera, an image processing device 12, an input device 13, and a display device 14. In the inspection apparatus 10, the imaging device 11 photographs the specimen 10A and outputs a color image (RGB image) of the specimen 10A to the image processing device 12.

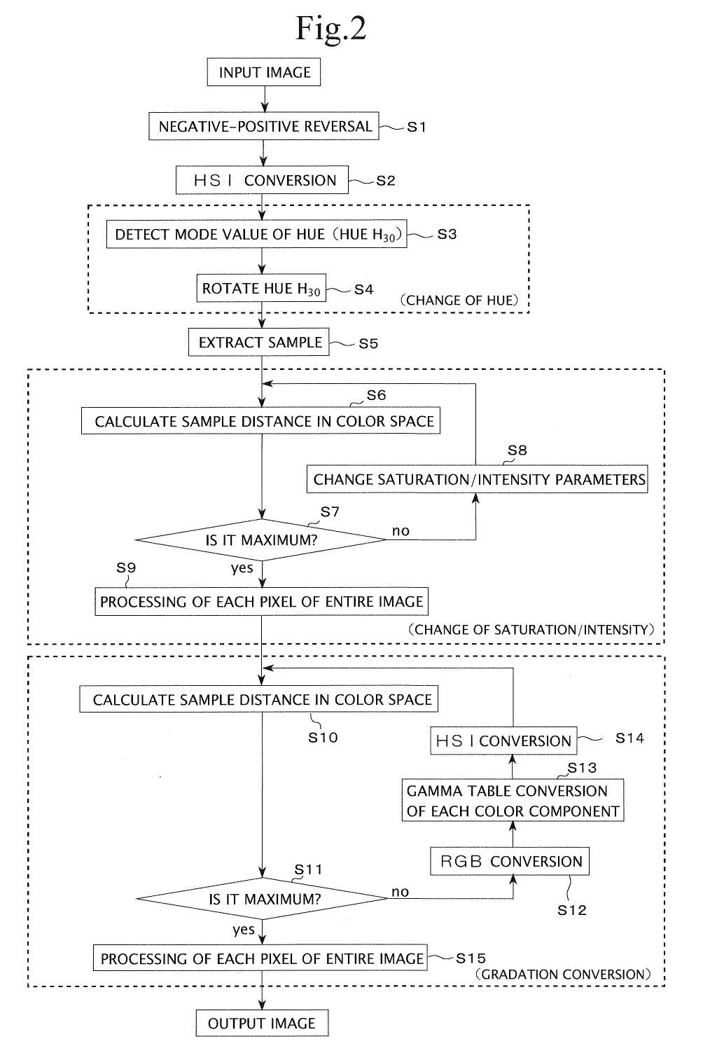

The image processing device 12 takes in the color image of the specimen 10A and processes the color image in accordance with the procedure of the flowchart shown in FIG. 2. In processing, a user instruction from the input device 13 is referred to as the need arises. In addition, the color image during or after processing is output to the display device 14 as the need arises.

The image processing device 12 is a computer in which an image processing program (FIG. 2) is installed. To install the image processing program, it is recommended to use a recording medium (CD-ROM etc.) in which the image processing program is recorded. Alternatively, it may also be possible to use carrier waves (including the image processing program) that can be downloaded via the Internet.

Next, the specific content of the processing (FIG. 2) in the image processing device 12 of the present embodiment will be described. The object of the processing is the color image (RGB image) of the specimen 10A. An example of the data path when processing the color image is shown in FIG. 3 (blocks 21 to 25).

After taking in the color image of the specimen 10A, the image processing device 12 subjects it to negative-positive reversal (step S1, block 21). In the color image before the reversal, the purple cells 15 to 18 are distributed in the white background and in the color image after the reversal, the green cells 15 to 18 are distributed in the black background. Because each image is a real image, the color difference for each kind of cell is extremely slight.

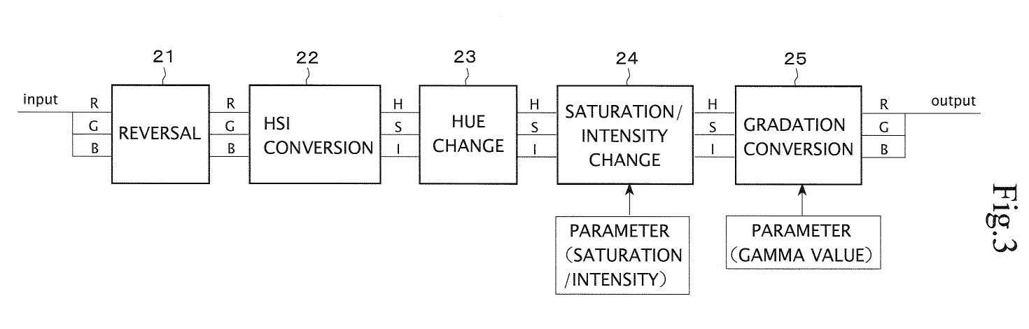

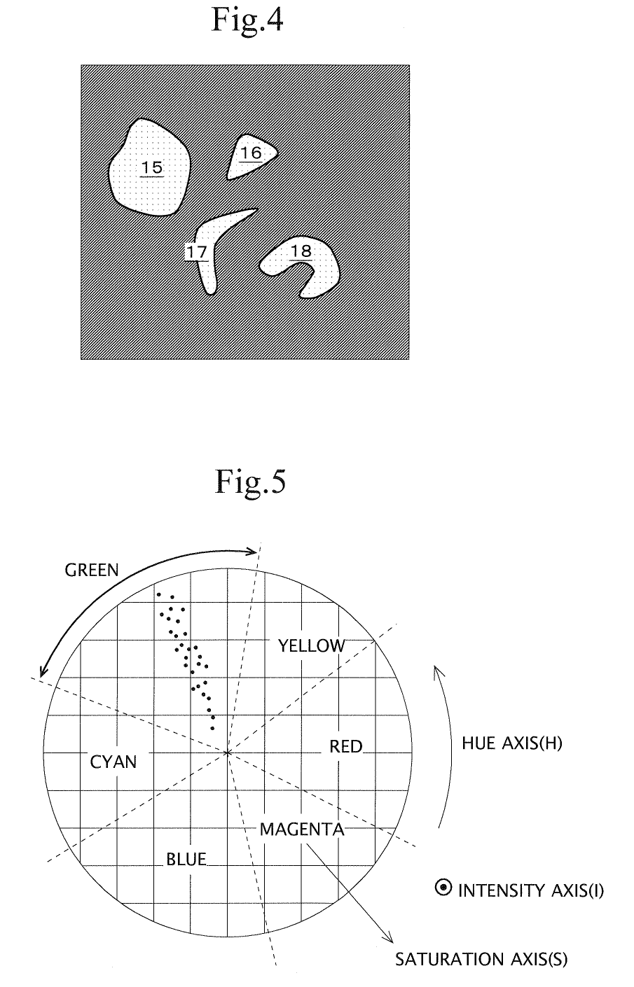

Because of this, it is difficult to explicitly distinguish the color difference for each kind of cell on the real image. The schematic diagram of the color image after the negative-positive reversal is shown in FIG. 4. In FIG. 4, to show that the color difference of each kind of cell is extremely slight, the cells 15 to 18 are hatched in the same way. The image processing device 12 in the present embodiment carries out the following processing to clarify the slight color difference in the real image.

In step S2 (block 22), the color image after the negative-positive reversal is subjected to HSI conversion. That is, the hue (H), the saturation (S), and the intensity (I) of each pixel are found based on each color component of red, green and blue (RGB) of each pixel of the color image.

The values (hue/saturation/intensity) of each pixel after the HSI conversion are plotted in a predetermined color space as, for example, “•” in FIG. 5. In the color space in FIG. 5, the circumferential direction in the plane of the paper denotes the hue axis (H), the radial direction denotes the saturation axis (S), and the direction perpendicular to the plane of the paper denotes the intensity axis (I). It can be seen that the plot positions of the values (hue/saturation/intensity) of each pixel are distributed near the center in the direction of the hue axis (H) in the green area.

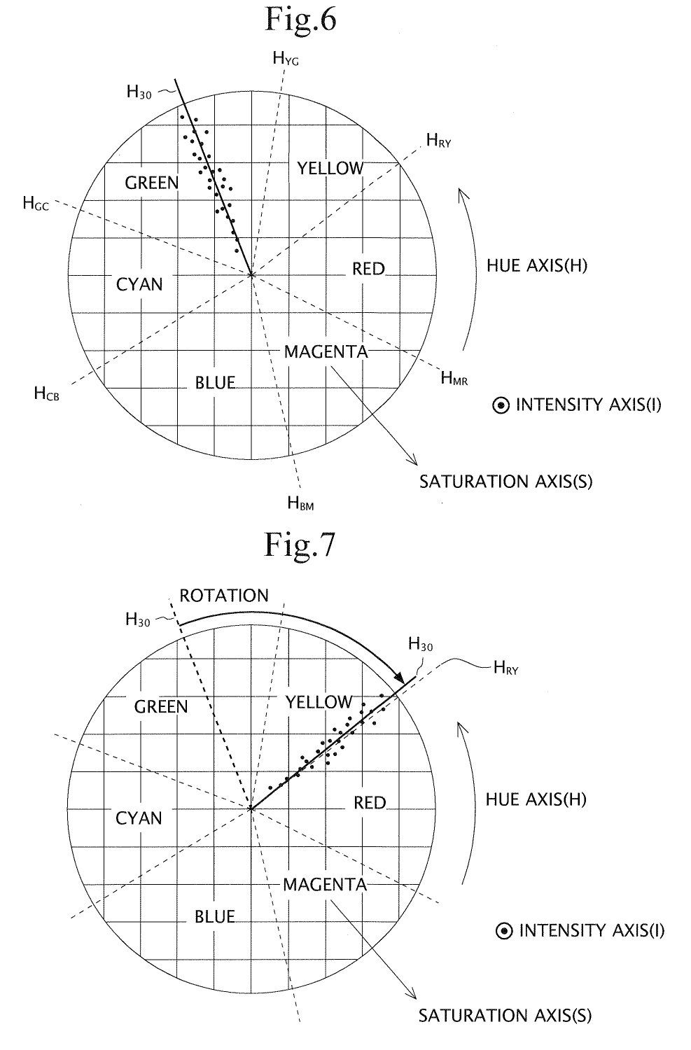

In the next steps S3, S4 (block 23), the hue of each pixel is changed. That is, after the mode value of the hue of each pixel (hue H₃₀ in FIG. 6) is detected, the hue H₃₀ is rotated (FIG. 7) so that the hue H₃₀ overlaps one of color boundaries (for example, any one of color boundaries H_{RY}, H_{YG}, H_{GC}, H_{CB}, H_{BM} and H_{MR}) and thus the hue of each pixel of the entire image is changed. A color boundary is a boundary value between two predefined hues.

In FIG. 7, an example is shown, in which the hue of each pixel is changed by rotating the hue H₃₀ so that it overlaps the boundary value between the red area and the yellow area (that is, the color boundary H_{RY}). In this case, the hue of each pixel is changed in accordance with the difference between the hue H₃₀ and the color boundary H_{RY} (the angular difference in the direction of the hue axis (H)).

By changing the hue as described above, the plot positions of the values (hue/saturation/intensity) of each pixel in the color space are distributed near the boundary value between red and yellow (color boundary H_{RY}). Because of this, it is possible to produce a color image (real image) in which the color difference of each kind of cell is clear by finding each color component of red, green, and blue (RGB) of each pixel based on the values (hue/saturation/intensity) of each pixel after the hue has been changed.

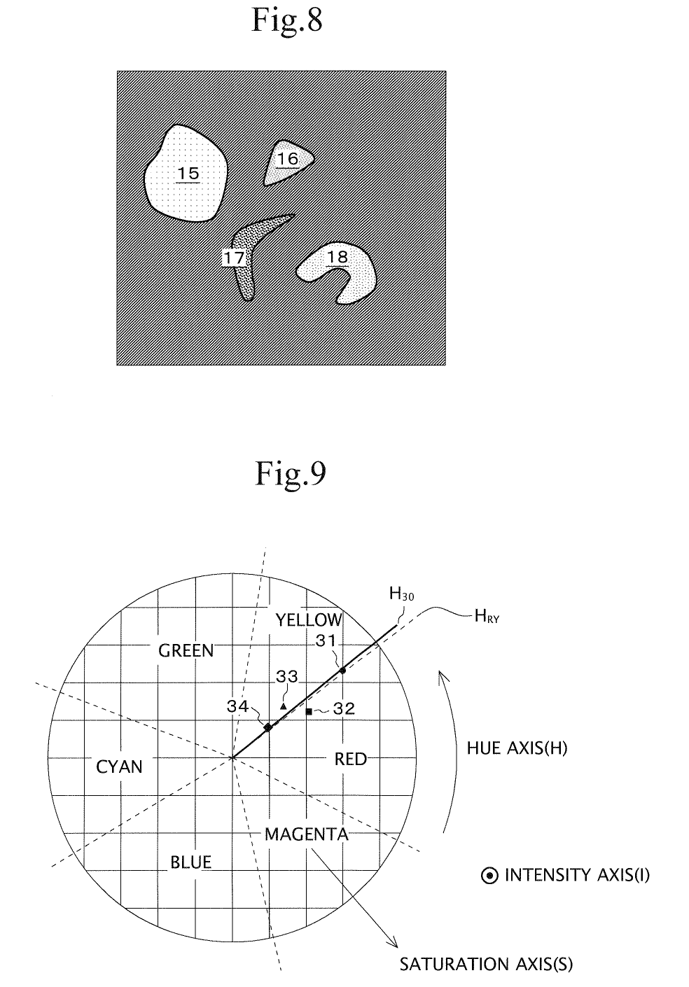

The schematic diagram of the color image after the hue has been changed is illustrated in FIG. 8. In FIG. 8, the cells 15 to 18 are differently hatched in order to explicitly indicate that the color difference for each kind of cell has been clarified.

The image processing device 12 in the present embodiment carries out the processing in steps S6 to S9 (block 24) and the processing in steps S10 to 515 (block 25) following the processing in step S5 in order to further clarify the color difference in the color image (real image).

First, in step S5, among the values (hue/saturation/intensity) of each pixel plotted in the color space (FIG. 7), the value of the hue H₃₀ or the value in the vicinity thereof is shown on the hue axis (H) and a plurality of target pixels 31 to 34 (refer to FIG. 9) indicative of different values from one another are extracted as samples on the saturation axis (S).

The samples (the plurality of the target pixels 31 to 34 of different saturations) may be extracted based on a user instruction through the input device 13 (FIG. 1), or may be extracted automatically within the image processing device 12. When the samples are extracted based on a user instruction through the input device 13, it is preferable to display the image in the color space (FIG. 7) on the display device 14.

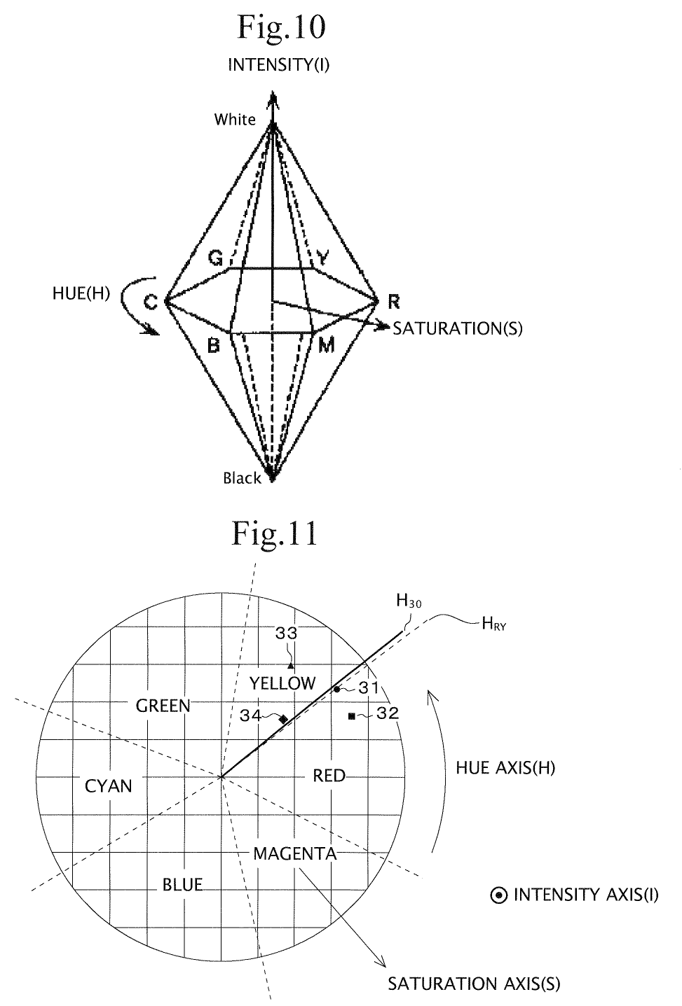

In the next steps S6 to S9 (block 24), the saturation/intensity of each pixel are changed so that the target pixels 31 to 34 become most distant from one another in the three-dimensional color space (for example, the color space of a twin six-sided pyramid model shown in FIG. 10) using the values (hue/saturation/intensity) of the target pixels 31 to 34 extracted in step S5.

Specifically, distances (sample distances) between the plurality of the target pixels 31 to 34 in the color space (FIG. 10) are calculated and the same calculation is repeated while maintaining the parameter of the hue of each pixel constant and changing the parameters of the saturation/intensity. Then, when the parameters of the saturation/intensity with which the sample distance is maximum are found, the saturation and the intensity of each pixel of the entire image are changed using the parameters and the processing in steps S6 to S9 (block 24) is ended.

The plot positions of the target pixels 31 to 34 at this point of time are shown in FIG. 11. As can be seen from the comparison with the plot positions (FIG. 9) before the saturation/intensity are changed, the plot positions after the change (FIG. 11) are distributed in a comparatively wide range on both sides with the boundary value (color boundary H_{RY}) between red and yellow sandwiched in between. The plot positions of other pixels, which are not shown, are distributed in a similar range.

Since the larger the distance in the color space, the larger the color difference in the real image, it is possible to produce a color image (real image) in which the color difference for each kind of cell is more clarified than the color image after the hue is changed (FIG. 8) by finding each color component of red, green and blue (RGB) of each pixel based on the values (hue/saturation/intensity) of each pixel after the saturation/intensity are changed.

In the next steps S10 to S15 (block 25), the processing in steps S12 to S14 is carried out in the middle of the repetition of the sample distance calculation similar to that in the above steps S6 to S9 (block 24).

In step S12, RGB conversion is carried out as pre-processing of step S13. That is, each color component of red, green and blue (RGB) of the respective target pixels 31 to 34 is found based on the values of the target pixels 31 to 34 after the hue/saturation/intensity are changed.

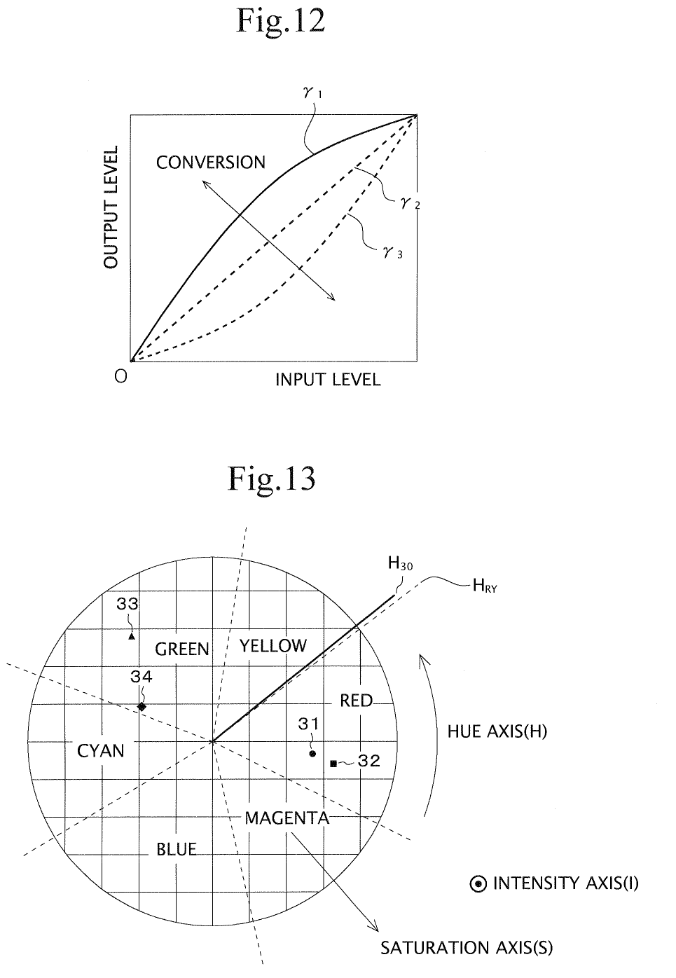

In step S13, gamma table conversion is carried out for each color component of red, green and blue (RGB) of the respective target pixels 31 to 34. That is, the data of the gradation conversion table corresponding to the gradation conversion curve (for example, any of the curves γ₁ to γ₃ in FIG. 12) of a predefined gamma value is read and the gradation of each color component of red, green and blue (RGB) is converted using the table. It is preferable to use a different table for each color component at this time.

In step S14, HSI conversion is carried out as post-processing of step S13. That is, the hue/saturation/intensity of the respective target pixels 31 to 34 are found based on each color component of red, green and blue (RGB) of the target pixels 31 to 34 after the gradation conversion. The hue/saturation/intensity of the respective target pixels 31 to 34 are used for the calculation of the sample distance in step S10.

Such processing in steps S12 to S14 is carried out repeatedly while changing the gamma value of the gradation conversion curve (FIG. 12) so that the target pixels 31 to 34 become most distant from one another in the color space (for example, FIG. 10). Then, when the gamma value with which the sample distance is maximum is found, the operation proceeds to the processing in the next step S15.

In step S15, the RGB conversion of the entire image is carried out first and then each color component of red, green and blue (RGB) of each pixel of the entire image is found. Then, the gamma table conversion is carried out for each color component of red, green and blue (RGB) of each pixel of the entire image. That is, the gradation of each color component of red, green and blue (RGB) is converted using the gradation conversion table of a gamma value with which the above sample distance is maximum. With this operation, the processing in steps S10 to S15 (block 25) is ended.

After the processing in step S15 is ended, the image processing device 12 in the present embodiment produces a color image (real image) of the specimen 10A based on each color component of red, green and blue (RGB) after the gradation conversion and outputs it, for example, to the display device 14 (FIG. 1) as a final result.

Here, the plot positions of the target pixels 31 to 34 when the sample distance is maximum in the processing in the above steps S10 to S15 (block 25) are shown in FIG. 13. As can be seen from the comparison with the previous plot positions (FIG. 9, FIG. 11), the plot positions in FIG. 13 are distributed in a very wide range on both sides with the boundary value (color boundary H_{RY}) between red and yellow sandwiched in between. The plot positions of other pixels, which are not shown, are also distributed in a similar range.

As already described, because the larger the distance in the color space, the larger the color difference in the real image, it is possible to obtain a color image (real image) in which the color difference for each kind of cell is more clarified than the color image after the hue is changed (FIG. 8) or the color image after the saturation/intensity are changed by producing a color image (real image) in step S15 based on the values (hue/saturation/intensity) of each pixel at the plot positions such as those in FIG. 13.

The image processing device 12 in the present embodiment takes in the color image of the specimen 10A and rotates the hue H₃₀ (FIG. 7) so that the mode value of the hue of each pixel (the hue H₃₀ in FIG. 6) overlaps one color boundary (for example, the color boundary H_{RY}) in the color space after subjecting it to negative-position reversal (FIG. 4) and changes the hue of each pixel of the entire image, and therefore, it is possible to clarify the slight color difference in the color image (real image) of the specimen 10A.

Consequently, the blood cells having substantially the same color when input are classified into each kind according to color and it is made possible to directly distinguish the color difference for each kind of cell in the color image (real image) of the specimen 10A and to diagnose the specimen 10A by color difference (to specify the individual kinds of cells).

In the diagnosis by the color difference, the standards for judgment are easy-to-see compared to the diagnosis by the difference in cell shapes. Because of this, it is possible for a person having no special knowledge about the cell shapes to make a diagnosis with ease. Further, the time required for the diagnosis can be shortened compared to the diagnosis by difference in cell shapes, and the variations in results due to the difference in skill and experience of a person who makes a diagnosis can also be reduced. In addition, it is easy to apply it to an automatic judgment using a computer.

Further, the diagnosis by the difference in cell shapes requires a magnification of about, for example, 1,000 (eyepiece 10×objective 100) of the image of specimen, and therefore, it is necessary to establish a liquid immersion state between the objective lens (not shown) and the specimen 10A and the labor and time used to be required to take in the color image of the specimen 10A. However, in the present embodiment, the diagnosis is made by the color difference, and therefore, detailed information about the cell shapes is not necessary. As a result, the magnification of the specimen image can be reduced (for example, about ×400) and the liquid immersion state between the objective lens and the specimen 10A is no longer necessary. Because of this, it is possible to take in the color image of the specimen 10A both easily and quickly.

The image processing device 12 in the present embodiment also changes the saturation and the intensity of each pixel of the entire image so that the sample distance between the target pixels 31 to 34 in the color space (FIG. 10) is maximum (FIG. 9 to FIG. 11), in addition to the change of the hue of each pixel of the entire image. Consequently, it is possible to further clarify the slight color difference in the color image (real image) of the specimen 10A.

Further, the image processing device 12 in the present embodiment converts the gradation of each color component of red, green and blue (RGB) of the entire image so that the sample distance between the target pixels 31 to 34 in the color space (FIG. 10) is maximum (FIG. 11 to FIG. 13), in addition to the change of the hue/saturation/intensity of each pixel of the above-mentioned entire image. Consequently, it is possible to further clarify the slight color difference in the color image (real image) of the specimen 10A.

The image processing device 12 in the present embodiment uses the gradation conversion table corresponding to the gradation conversion curve (for example, any of the curves γ₁ to γ₃ in FIG. 12) when converting the gradation of each color component of red, green and blue (RGB) of each pixel, and therefore, the processing of the gradation conversion can be carried out quickly. However, the gradation conversion may be carried out by the operation processing without using the table.

Further, the image processing device 12 in the present embodiment carries out the processing, such as changing of the hue, using the color image after negative-positive reversal (FIG. 4), and therefore, it is possible to obtain a visual field of familiar colors similar to the period of time of dark field observation of the specimen 10A. However, the processing, such as the similar changing of the hue, may be carried out using the color image before negative-positive reversal.

### Description of Second Embodiment

In a second embodiment, an example will be described, in which the specimen 10A is a bone marrow specimen including Giemsa-stained eosinophils. A color image (real image) output from the imaging device 11 to the image processing device 12 is a photographed image of eosinophils. Then, the same processing (FIG. 2) as in the first embodiment is carried out for the color image.

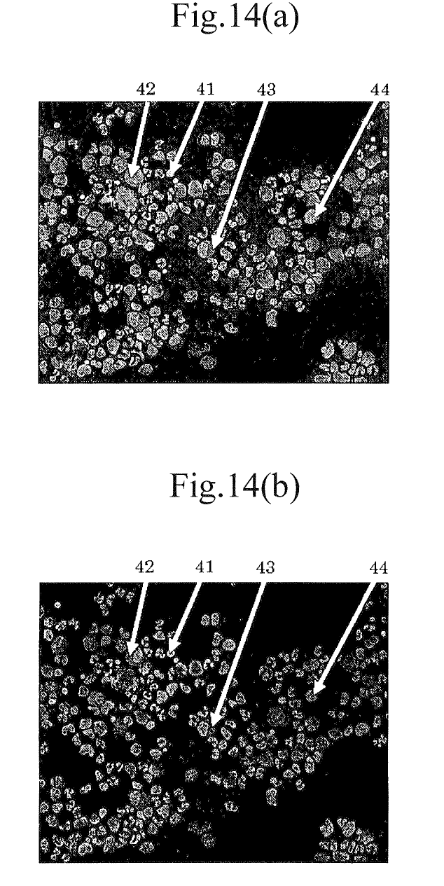

In the color image after negative-positive reversal (FIG. 14(a)), the background is black and many green cells are distributed therein. The many cells include eosinophils, however, they are the same green as that of other cells and the color difference between the kinds of cell is extremely slight. Because of this, it is difficult to explicitly distinguish the color difference for each kind of cell in the color image (FIG. 14(a)).

On the other hand, in the color image (FIG. 14(b)) after having been subjected to the processing in FIG. 2, cells of various colors are distributed in the black background, as a result. For example, a cell 41 assumes pink, cells 42, 43 assume green, and a cell 44 assumes red. Among these, it is known that the cells 42, 43 that remain unchanged, that is, green, correspond to eosinophils and the cells 41 44 that have changed from green to other colors correspond to leukocytes. Because of this, in the color image after the processing (FIG. 14(b)), it is possible to identify that the part the cytoplasm of which is green is eosinophils.

According to the second embodiment, when a bone marrow specimen including Giemsa-stained eosinophils is an object of the pathological diagnosis, it is possible to directly distinguish eosinophils from other leukocytes by the color difference in the color image (FIG. 14(b)) having been subjected to the processing in FIG. 2. Because of this it is possible to make a diagnosis based on the easy-to-see standards of judgment, that is, the color difference for each kind of cell.

At the time of diagnosis, it is preferable to select a target area with a predefined color value (for example, a green area corresponding to eosinophils) in the color image (FIG. 14(b)) after having been subjected to the processing in FIG. 2 to use it for the pathological judgment. The color value includes a value of each color component of red, green and blue (RGB) or values of hue/saturation/intensity of each pixel. By selecting a target area with the same color value, the pathological judgment is made easier.

The selection of a target area may also be carried out automatically within the image processing device 12 or based on a user instruction from the input device 13 (FIG. 1). The selection based on the user instruction may be carried out based on, for example, a color value at a portion on the screen of the display device 14 at which a user clicks. It is preferable to display the selected target area so that is can be distinguished from other parts.

Further, at the time of diagnosis, it is preferable to measure the number or area ratio of target areas in the color image (FIG. 14(b)) after having been subjected to the processing in FIG. 2. When counting the number of target areas, it is preferable to detect a closed area with a predetermined color value as individual target areas by detecting already known edges (detection of contours) as its pre-processing.

The number of target areas is the number of those in the entire color image (FIG. 14(b)) or the number of those in a partial area. The area ratio of the target areas is the ratio of the number of pixels in the target area to the number of pixels of the entire color image (FIG. 14(b)), or the ratio of the number of pixels in the target areas to the number of pixels in the cell area in the image, and so on. By making such measurements, the pathological judgment is made easier.

### Description of Other Embodiments

In the above-described embodiments, the change of the saturation/intensity (S6 to S9) and the gradation conversion (S10 to S15) are carried out after the change of the hue (S3, S4), however, the present invention is not limited to those. Either of the change of the saturation/intensity (S6 to S9) and the gradation conversion (S10 to S15) may be omitted. When the gradation conversion (S10 to S15) is omitted, it is required to carry out the processing of RGB conversion after step S9. When both of the change of the saturation/intensity (S6 to S9) and the gradation conversion (S10 to S15) are omitted, the processing in step S5 is no longer necessary and it is required to carry out the processing of RGB conversion after the processing in step S4. When the change of the saturation/intensity (S6 to S9) is omitted, it is possible to apply a color space of a single six-sided pyramid model or cylindrical model, in addition to the color space of twin six-sided pyramid model (FIG. 10).

In the above-described embodiments, an example is described, in which the color image input to the image processing device 12 is an RGB image, however, the present invention is not limited to this. The present invention can be applied also when the color image is a YCbCr image. In this case, after the YCbCr image is converted into an RGB image, the processing in FIG. 2 is initiated.

“The many features and advantages of the embodiments are apparent from the detailed specification and, thus it is intended by the appended claims to cover all such features and advantages of the embodiments that fall within the true spirit and scope thereof. Further, since numerous modifications and changes will readily occur to those skilled in the art, it is not desired to limit the inventive embodiments to exact construction and operation illustrated and described, and accordingly all suitable modifications and equivalents may be resorted to, falling within the scope thereof.”

1. An image processing device, comprising:
a processing unit that finds a hue of each pixel of a color image;
a detecting unit that detects a mode value of said hue; and a changing unit that changes the hue of each pixel of said color image in accordance with a difference between a boundary value of two predefined hues and said mode value.

2. The image processing device according to claim 1, wherein:
said processing unit finds saturation and intensity of each pixel, in addition to said hue; and
said changing unit also changes said saturation and said intensity, in addition to the change of said hue and changes the saturation and the intensity of each pixel of said color image so that a plurality of target pixels different in said saturation becomes most distant from one another in a color space including a hue axis, a saturation axis and an intensity axis.

3. The image processing device according to claim 2, further comprising, a converting unit which finds each color component of red, green and blue of each pixel of said color image based on the hue, the saturation and the intensity after the change by said changing unit and converts a gradation of said each color component so that said plurality of target pixels becomes most distant from one another in said color space.

4. The image processing device according to claim 1, wherein:
said processing unit finds saturation and intensity of each pixel, in addition to said hue; and
said device further comprises a converting unit which finds each color component of red, green and blue of each pixel in said color image based on the hue after the change by said changing unit and the saturation and the intensity found by said processing unit and converts a gradation of said each color component so that a plurality of target pixels different in said saturation becomes most distant from one another in a color space including a hue axis, a saturation axis and an intensity axis.

5. The image processing device according to claim 3 or 4, wherein said converting unit converts the gradation of said each color component using a table.

6. The image processing device according to claim 2 or 4, further comprising, an extracting unit that extracts said plurality of target pixels based on a user instruction.

7. The image processing device according to claim 1, wherein said processing unit finds at least said hue of each pixel using said color image after negative-positive reversal.

8. The image processing device according to claim 1, further comprising, a selecting unit that selects a target area with a predefined color value in said color image.

9. The image processing device according to claim 8, wherein said selecting unit selects said target area based on the user instruction.

10. The image processing device according to claim 8, further comprising, a measuring unit that measures the number or area ratio of said target areas in said color image.

11. The image processing device according to claim 1, wherein said color image is a photographed image of eosinophil.

12. A computer readable medium storing an image processing program causing a computer to execute:
a processing operation of finding a hue of each pixel of a color image;
a detecting operation of detecting a mode value of said hue; and
a changing operation of changing the hue of each pixel of said color image in accordance with a difference between a boundary value of two predefined hues and said mode value.
